(19) United States
(12) Patent Application Publication
(10) Pub. No.: US 2011/0155852 A1
(43) Pub. Date: Jun. 30, 2011

(54) STIFFENING ELEMENT FOR AN AIRCRAFT AND A SURFACE STRUCTURE WITH A STIFFENING ELEMENT OF THIS TYPE

(75) Inventor: Torsten Noebel, Neuendeich (DE)

(73) Assignee: AIRBUS OPERATIONS GMBH, Hamburg (DE)

(21) Appl. No.: 12/980,378

(22) Filed: Dec. 29, 2010

Related U.S. Application Data
(60) Provisional application No. 61/290,508, filed on Dec. 29, 2009.

(30) Foreign Application Priority Data
Dec. 29, 2009 (DE) 10 2009 060 693.9

(51) Int. Cl. B64C 1/06

(52) U.S. Cl. 244/131

(57) ABSTRACT

A stiffening element for stiffening a surface structure of an aircraft includes a web and a foot configured to connect to the surface structure. The foot includes an inner section near the web and an outer section further from the web than the inner section. The outer section has a greater elasticity than the inner section.

Disclosed is a stiffening element 10, for example a T-, I-, L-, Z-, J or Omega-stiffener, of a fiber-reinforced composite material, for purposes of stiffening a surface structure 12 of an aircraft, whose at least one foot 18, 20 has sections 32, 34 with differing stiffnesses; also disclosed is a surface structure 12 for an aircraft with stiffening elements 10 of this type.

### CROSS REFERENCE TO RELATED APPLICATIONS

This application claims priority from U.S. Provisional Patent Application Ser. No. 61/290,508, filed Dec. 29, 2009 and German Patent Application DE 10 2009 060 693.9, filed Dec. 29, 2009, which are each hereby incorporated by reference herein in their entirety.

### FIELD

The invention relates to a stiffening element for an aircraft and a surface structure with at least one stiffening element of this type.

### BACKGROUND

A stiffening element of this type is shown, for example, in the patent DE 10 2006 045 633 B4 of the applicant (cf. also FIGS. 1 and 2). This stiffening element 1 forms longitudinal stiffeners of a rear body structure of an aircraft skin field 2 and has a foot 4 with a constant cross-section for purposes of attachment to the skin field 2, and a web 6 or flange extending orthogonally from the foot 4. It consists of a fiber-reinforced composite material, for example CFRP, and is connected via a bonded joint 8 to the skin field. However, under unfavourable, but not improbable, loading a failure of the bonded joint 8 can occur, as represented in FIGS. 1 and 2, and thus a separation of the foot 4 from the skin field 2, leading directly to an immediate failure of the rear body structure. A failure of the bonded joint 8 occurs, for example, if in the presence of an internal pressure loading the skin field undergoes a deformation that the foot 4 cannot follow (FIG. 1). Likewise what is called post-buckling can result in a separation of the foot 4 from the skin field 2 (FIG. 2). Furthermore a separation of the foot 4 can occur in the event of shock-type impacts and similar. To prevent a separation of the stiffening element 1, the stiffness of the skin field 2 is conventionally increased via additional material web layers, so that while the skin field 2 has a deformability matched to the foot 6, it is also provided with corresponding additional weight.

### SUMMARY

An aspect of the present invention is to create a stiffening element stiffening a surface structure, which eliminates the above-cited disadvantages and can reliably be connected with the surface structure, and a surface structure for an aircraft with at least one stiffening element of this type.

In an embodiment, the present invention provides a stiffening element for stiffening a surface structure of an aircraft. The stiffening element includes a web and a foot configured to connect to the surface structure. The foot includes an inner section near the web and an outer section further from the web than the inner section. The outer section has a greater elasticity than the inner section.

### BRIEF DESCRIPTION OF THE DRAWINGS

Exemplary embodiments of the present invention are described in more detail with reference to the schematic drawings, in which:

FIGS. 1 and 2 show a cross-section through a conventional stiffening element attached to a surface structure, and

FIG. 3 shows a cross-section through a stiffening element in accordance with an embodiment of the invention.

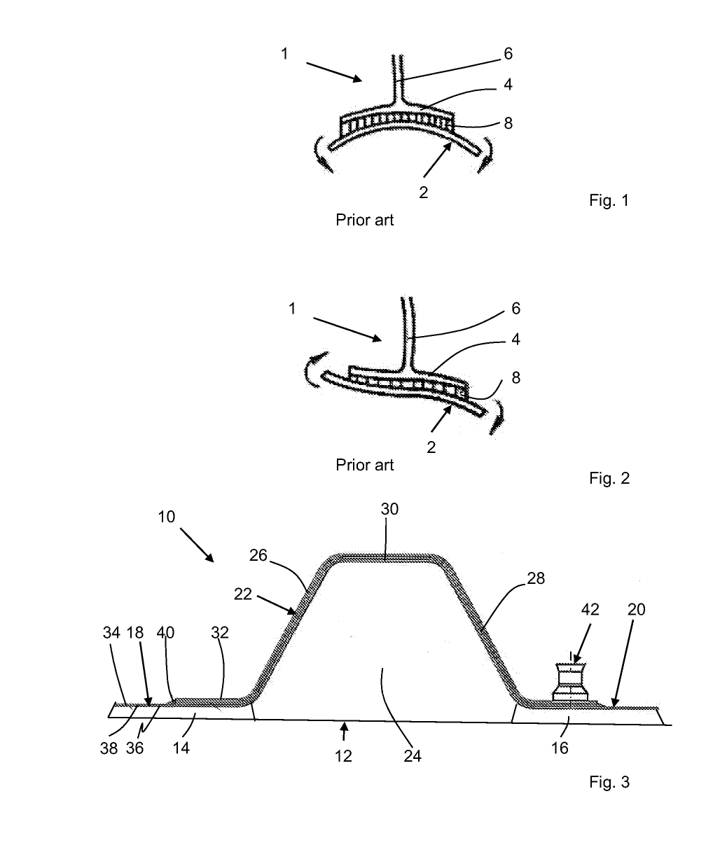

### DETAILED DESCRIPTION

A stiffening element in accordance with an embodiment of the invention for purposes of stiffening a surface structure of an aircraft has a web and at least one foot for purposes of connecting to the surface structure. In accordance with the embodiment the at least one foot has a inner section near the web and at least one outer section further from the web, which has a greater elasticity than the inner section. By virtue of the increased elasticity in the edge region, i.e. the run-out of the foot, this is more pliant and can thus follow better the buckling behaviour of the surface structure, as a result of which critical stresses at the run-out of the foot to the surface structure are reduced, resulting in a significantly later separation of the foot from the surface structure. At the same time the stiff inner section effects a sufficient stabilisation of the web. The greater deformability of the foot thereby obtained can effectively be taken into account in the dimensioning of the skin field, since the latter's elasticity no longer has to be reduced by means of additional material web layers.

In a preferred embodiment the sections have a connecting surface facing towards the surface structure in a step-less manner, wherein the outer section is designed to be of reduced material section compared with the inner section. This can, for example, take place via a decrement in which the outer section is designed with a reduced number of material web layers compared with the inner section.

To avoid a sudden decrement, i.e. to form a harmonic transition between the foot sections in the region of the decrement, a paste-type filler is arranged in the region of the decrement in one embodiment. Similarly, the decrement can also have a plurality of individual decrements and can thus take place in a step-by-step manner.

The load introduction from the surface structure into the stiffening element can be improved if the connecting surface is formed from a material web extending over the foot sections. In particular the load distribution in the stiffening element can be improved if the material web is guided over the web, at least in some sections, or a material web layer forms the web.

The production of the stiffening element in accordance with an embodiment of the invention can be simplified if the web and the inner section near the web have a uniformly constant material thickness. However, in another embodiment the inner section and the web have different material thicknesses.

In order to be able also to attach the stiffening element by means of mechanical connecting elements, such as e.g. rivets, to the surface structure, it is advantageous if the inner section has an extension in the transverse direction, which enables the accommodation of mechanical connecting elements of this type.

A surface structure for an aircraft in accordance with an embodiment of the invention is strengthened via a stiffening structure, which has a multiplicity of stiffening elements with in each case a web and at least one foot. The feet have in each case an inner section near the web and at least one outer section further from the web, which is embodied so as to be more elastic than the inner section. By this means critical stresses, in particular in the lateral run-out of the foot, are reduced, which in particular in stiffening structures that are bonded to the surface structures leads to a lower loading of the bonded joints. The surface structure can, for example, be a skin field made from a fiber-reinforced composite material such as CFRP, and the stiffening structure can be a corresponding rear body structure, consisting of a multiplicity of stringers and frames made from a fiber-reinforced composite material. Similarly, the surface structure can represent a control surface or a wing surface, and the stiffening structure can form frames or struts. Examples are vertical tail or horizontal tailplane surfaces, and landing flap surfaces.

In accordance with FIG. 3 a preferred stiffening element 10 is designed for purposes of stabilising a skin field 12 of an aircraft fuselage as an Omega-stiffener. The stiffening element 10 and the skin field consists in each case of a fiber-reinforced composite material, and are connected together by means of two bonded joints 14, 16.

The stiffening element 10 has two feet 18, 20, located at a distance from one another, and a web 22 that defines a trapezoidal cavity 24. The web 22 has two web flanks 26, 28 set towards one another, which extend in each case from one of the feet 14, 16, and are connected with one another via a central web section 30.

The feet 14, 16 have in each case an inner section 32 near the web and an outer section 34 further from the web, which together form a plane connecting surface 36 for purposes of connecting to the skin field 12. Compared with the inner section 32 the outer section 34 is designed to be decremented and thus of reduced material section and elastic; this is achieved by means of a reduction of material web layers, or laminates of the stiffening element 10. Here the outer section 34 can be formed from just one material web 38, or one laminate.

The inner sections 32, and also the web 22, have a uniformly constant material thickness and are thereby designed to be appropriately stiff. For purposes of optimising the load introduction into the stiffening element 10, and also the load distribution in the stiffening element 10, the at least one material web 38 forming the outer sections 34, i.e. the connecting surface 36, is guided over the inner sections 32 and the web 22.

For purposes of avoiding peak stresses in the transition between the inner and outer sections 32, 34, a paste-type filler 40 is in each case arranged in the region of the decrement.

In order to be able to attach the stiffening element 10 to the skin field 12, even after the unlikely event of a separation, i.e. a failure of the bonded joints 14, 16, the outer sections 34, have a extension in the transverse direction such that the feet 18, 20, can also be connected by means of mechanical connecting elements 42, such as e.g. rivets, with the skin field 12.

Disclosed is a stiffening element 10, for example a T-, I-, L-, Z-, J or Omega-stiffener, of a fiber-reinforced composite material, for purposes of stiffening a surface structure 12 of an aircraft, whose at least one foot 18, 20 has sections 32, 34 with differing stiffnesses; also disclosed is a surface structure 12 for an aircraft with stiffening elements 10 of this type.

While the invention has been particularly shown and described with reference to preferred embodiments thereof, it will be understood by those skilled in the art that various changes in form and details may be made therein without departing from the spirit and scope of the invention.

### REFERENCE SYMBOL LIST

1 Stiffening element
2 Skin field
4 Foot
6 Web
8 Bonded joint
10 Stiffening element
12 Skin field
14 Bonded joint
16 Bonded joint
18 Foot
20 Foot
22 Web
24 Cavity
26 Web flank
28 Web flank
30 Web section
32 Inner section
34 Outer section
36 Connecting surface
38 Material web
40 Filler
42 Connecting element

What is claimed is:

1. A stiffening element for stiffening a surface structure of an aircraft, the stiffening element comprising:
a web; and
a foot configured to connect to the surface structure, the foot including an inner section near the web and an outer section further from the web than the inner section, the outer section having a greater elasticity than the inner section.

2. The stiffening structure recited in claim 1, wherein the inner and outer sections form a step-less connecting surface configured to face the surface structure, and wherein the outer section has a reduced material section compared to the inner section.

3. The stiffening structure recited in claim 2, wherein the reduction of material defining the reduced material section occurs over at least one decrement.

4. The stiffening element recited in claim 3, wherein a filler is disposed in a vicinity of the at least one decrement so as to form a harmonic transition between the inner section and outer section.

5. The stiffening element as recited in claim 2, wherein the outer section has a smaller number of material web layers than the inner section.

6. The stiffening element as recited in claim 3, wherein the outer section has a smaller number of material web layers than the inner section.

7. The stiffening element as recited in claim 4, wherein the outer section has a smaller number of material web layers than the inner section.

8. The stiffening element as recited in claim 2, wherein the connecting surface is formed by a first material web that extends over the inner and outer sections.

9. The stiffening element as recited in claim 3, wherein the connecting surface is formed by a first material web that extends over the inner and outer sections.

10. The stiffening element as recited in claim 4, wherein the connecting surface is formed by a first material web that extends over the inner and outer sections.

11. The stiffening element as recited in claim 8, wherein the first material web forms a material web layer of the web.

12. The stiffening element as recited in claim 1, wherein the inner section and the web have a uniformly constant material thickness.

13. The stiffening element as recited in claim 1, wherein the inner section and the web have different material thickness.

14. The stiffening element as recited in claim 1 wherein the inner section has a transverse section configured to accommodate a mechanical connecting element.

15. The stiffening element as recited in claim 2, wherein the inner section and the web have a uniformly constant material thickness.

16. The stiffening element as recited in claim 2, wherein the inner section and the web have different material thickness.

17. The stiffening element as recited in claim 2, wherein the inner section has a transverse section configured to accommodate a mechanical connecting element.

18. A structure comprising a surface structure for an aircraft and a stiffening structure configured to strengthen the surface structure, the stiffening structure comprising a plurality of stiffening elements each including a web and at least one foot, the at least one foot including an inner section near the web and an outer section further from the web than the inner section, the outer section having greater elasticity than the inner section.
